(19) United States
(12) Patent Application Publication
(10) Pub. No.: US 2022/0410363 A1
(43) Pub. Date: Dec. 29, 2022

(54) FLEXIBLE MAGNETIC MAT

(71) Applicant: Walter R. Tucker Enterprises, Ltd. D/B/A E-Z Red Company, Deposit, NY (US)

(72) Inventor: Robert CACCIABEVE, Boonton, NJ (US)

(73) Assignee: Walter R. Tucker Enterprises, Ltd. D/B/A E-Z Red Company, Deposit, NY (US)

(21) Appl. No.: 17/897,859

(22) Filed: Aug. 29, 2022

Related U.S. Application Data
(63) Continuation-in-part of application No. 17/237,414, filed on Apr. 22, 2021.
(60) Provisional application No. 63/238,549, filed on Aug. 30, 2021.

(51) Int. Cl. B25H 3/00

(52) U.S. Cl. CPC B25H 3/003

(57) ABSTRACT

A flexible magnetic mat is disclosed having a flexible mat having a top wall, a bottom wall, a first side wall and a second side wall. The top wall has a plurality of openings each adapted to expose a magnet. The bottom wall has a retaining member extending downwardly from the bottom wall and adapted to receive the magnet by friction fit. The magnet is inserted in the retaining member through an opening in the retaining member. The top wall of the flexible magnetic mat is adapted to magnetically hold the tools on the top of the mat and the bottom wall of the flexible mat is adapted to magnetically attach to different shaped ferrous surfaces.

### RELATED APPLICATION

This application claims benefit of U.S. Provisional Application Ser. No. 63/238,549, filed Aug. 30, 2021, entitled “Flexible Magnetic Mat,” and is a continuation-in-part of U.S. application Ser. No. 17/237,414, filed Apr. 22, 2021, entitled “Flexible Magnetic Socket Holder,” which applications are incorporated herein by reference in their entirety.

### FIELD OF THE INVENTION

The present invention relates to a socket holder and a tool holder. More particularly, the invention relates to a flexible magnetic socket holder and a flexible magnetic tool holder. The magnets will hold the sockets or tools on the holder or mat and the magnets will also attach the holder or mat to almost any shape ferrous surface.

### BACKGROUND OF THE INVENTION

Socket wrenches and similar tools are used in numerous applications, including in automotive garages. Preferably, the different size sockets for a socket wrench should be maintained by size and for ease in use by a worker. The art is replete with different devices for holding sockets, including, for example, magnetic socket holders such as disclosed in U.S. Pat. No. 5,743,394. These known devices have various shortcomings, including that the sockets may fall off of a socket holder and may not be used in tight workspaces.

Similarly, tools, sockets, drill bits, nuts, bolts, screws, parts and the like (hereafter collectively referred to as “tools”) are used in a garage or other work area in close relation to the work, e.g. an automobile. The tools may be set on the ground and picked up as needed. The tools may be knocked over, not maintained in an organized manner, etc., e.g. when removing parts from an automobile. There are known trays, toolboxes, and the like for maintaining the tools. However, these devices have drawbacks and improvement is possible.

The shortcomings of the known devices for holding sockets and tools are addressed by the present inventions.

### SUMMARY OF THE INVENTION

The invention is directed to socket holder. The socket holder includes an elongated strip made of a flexible material such as a thermoplastic rubber (TPR) or silicone. There are a plurality of posts on the socket holder over which a socket is placed. The posts align the sockets in place but are not used to secure the sockets to the strip. Rather, there are series of magnets, one under each post, perpendicular to the axis of the elongated strip. The magnets are inserted from the side or bottom of the elongated strip thereby allowing for the sockets to magnetically grip the top of the flexible elongated strip and hold the sockets in place. The magnets are also preferably exposed from the underside of the elongated strip and allow the strip through the magnets to grip any shape/arc/angled ferrous surface.

Features and benefits of the socket holder invention include: the flexibility of the elongated strip with the magnets. The unique design of the socket holder allows a manufacturer to use the same mold to make a flexible version or a non-flexible version of the socket holder. Because each socket is held individually to the elongated strip by the magnet, the sockets will not peel off the strip. Each magnet is exposed at the top of the strip for engaging the socket and exposed at the bottom of the strip for attachment to another surface. Because the device is flexible, it may be attached to almost any ferrous surface, including a car wheel well, or over an arc, or over an angled shaped object. The individual posts may be made in a number of shapes, e.g. square, hex, X, round, S or the like.

Accordingly, the invention is directed to a flexible magnetic socket holder comprising a flexible elongated strip having a top wall, a bottom wall, a first side wall and a second side wall. The top wall has a plurality of posts each adapted to receive a socket and having an opening on each side of the posts for exposing a magnet. The bottom wall has a retaining member extending downwardly from the bottom wall and adapted to receive the magnet. The first side wall and the retaining member have an opening adapted to receive the magnet and retain the magnet by friction fit. The second side wall is adapted to retain the magnet in the retaining member. The magnet is inserted in the retaining member through the opening in the first side wall and the retaining member. The top wall of the flexible elongated strip is adapted to magnetically hold the sockets at each post and the bottom wall of the flexible elongated strip is adapted to magnetically attach to different shaped ferrous surfaces.

The present invention is further directed to a flexible magnetic mat. The flexible magnetic mat is a multi-purpose flexible magnetic mat which may function as a tool organizer that holds parts and tools to any curved or tilted ferrous surface. The invention is useful for almost any angled surface a worker is working on, e.g. an automobile fender, the underside of an automobile hood, etc. The flexible magnetic mat is preferably made of ultra-flexible TPR that will fold, bend, or roll anyway as needed; while always returning to its original shape. The flexible magnetic mat preferably uses strong neodymium magnets which hold tools on the mat. The mat will save a worker countless hours and stress walking back and forth between a toolbox and work area. A worker may roll her tools up in the flexible magnetic mat and bring them along with her. The mat has a low profile, which is useful when working in tight spaces or for keeping tools organized in a tool drawer. High visibility colors for the mat mean never losing small screws, springs, washers, or other small hardware while repairing or servicing automobiles, power tools, electronics, lawn mowers, etc. The flexible magnetic mat is a perfect organizational tool for not only mechanics, electricians and plumbers but also work great for DIY'ers and homeowners.

Features of the flexible magnetic mat include: (1) Ultra-Flexible: the mat will fold, bend, or roll any way needed; always returning to its original shape. Keeps tools organized while working on any curved or angled ferrous surface as well; (2) Strong Embedded Magnets: the mat sticks to virtually any ferrous surface and tools will stick to it. Prevents tools from moving around in the tool-box drawer or on the tool cart. The grid of magnets helps a worker stay organized chronologically as he disassembles an article; (3) Unique method for embedding magnets into the TPR material: the molding technique used to hold the magnets into the TPR material is new and unique; (4) Non-Marring TPR Material: the unique TPR design is built to be used in all work and storage areas without worry of the holder scratching or denting surfaces; (5) Any-tool, anywhere: the mat keeps tools accessible and organized anywhere one is working; (6) Low-profile, with a large surface area: less than ¼ inch tall, this mat will fit in tight spaces and is great for storage. Dimensions: 8.75 in. length×5.5 in. width×0.19 in. thick; (7) Easy to clean: soap and water will do the trick; and (8) High Visibility: the mat comes in high visibility colors so tools are easy to find.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a perspective view of the flexible magnetic socket holder of the invention.

FIG. 2 is a top view of the socket holder of FIG. 1.

FIG. 3 is a side view of the socket holder of FIG. 1.

FIG. 3A is a side cross-sectional view taken along line 3A-3A of FIG. 2.

FIG. 3B is a cross-sectional view taken along line 3B-3B of FIG. 3.

FIG. 4 is a bottom view of the socket holder of FIG. 1.

FIG. 5 is a perspective view of a flexible magnetic socket holder having two columns for holding two different size sockets.

FIG. 6 is a top view of the socket holder of FIG. 5.

FIG. 7 is a side view of the socket holder of FIG. 5.

FIG. 7A is a cross-sectional view taken along lines 7A-7A of FIG. 7.

FIG. 8 is a bottom view of the socket holder of FIG. 6.

FIG. 9 is a perspective view of the flexible magnetic mat of the invention.

FIG. 9A is a top view of the mat of FIG. 9.

FIG. 9B is a bottom view of the mat of FIG. 9.

FIG. 9C is a side view of the mat of FIG. 9.

FIG. 9D is an end view of the mat of FIG. 9.

FIG. 10 is another top perspective view of the mat of FIG. 9.

FIG. 10A is a cross-sectional view of the mat of FIG. 10 taken along line 10A-10A.

FIG. 10B an enlarged view taken from FIG. 10A.

FIG. 11 is the mat of FIG. 9 showing the mat in a twisted configuration illustrating the flexibility of the mat.

FIG. 12 is the mat of FIG. 9 in top view in a partially folded position.

FIG. 12A is the mat of FIG. 12 in a bottom view in a partially folded position.

FIG. 12B is the mat of FIG. 12 in a folded position.

FIG. 13 is a perspective view of another embodiment of the flexible magnetic mat of the invention having a hexagonal shape.

FIG. 13A is a top view of the mat of FIG. 13.

FIG. 13B is a bottom view of the mat of FIG. 13.

FIG. 13C is a side view of the mat of FIG. 13.

FIG. 13D is an end view of the mat of FIG. 13.

FIG. 14 is a top view of the mat of FIG. 13.

FIG. 14A is a cross-sectional view of the mat of FIG. 14 taken along line 14A-14A.

FIG. 14B is an enlarged view taken from FIG. 14A.

FIG. 15 is the mat of FIG. 13 in a twisted configuration illustrating the flexibility of the mat.

FIG. 15A is a top view of the mat of FIG. 13 in a partially folded position.

FIG. 15B is a view of the mat of FIG. 13 in a folded position.

### DETAILED DESCRIPTION OF THE PREFERRED EMBODIMENTS

The inventions are directed to a socket holder for holding sockets for socket wrenches or similar tools and to a mat for holding tools. The inventions include common subject matter with respect to the use of a flexible material and magnets. The socket holder will be first discussed and then the mat.

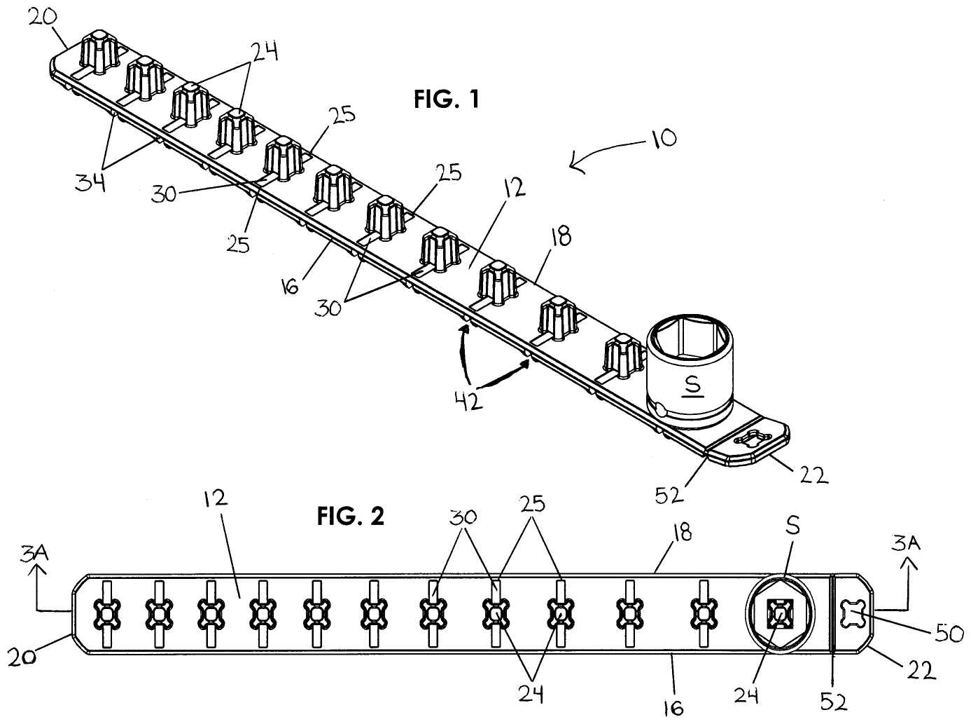

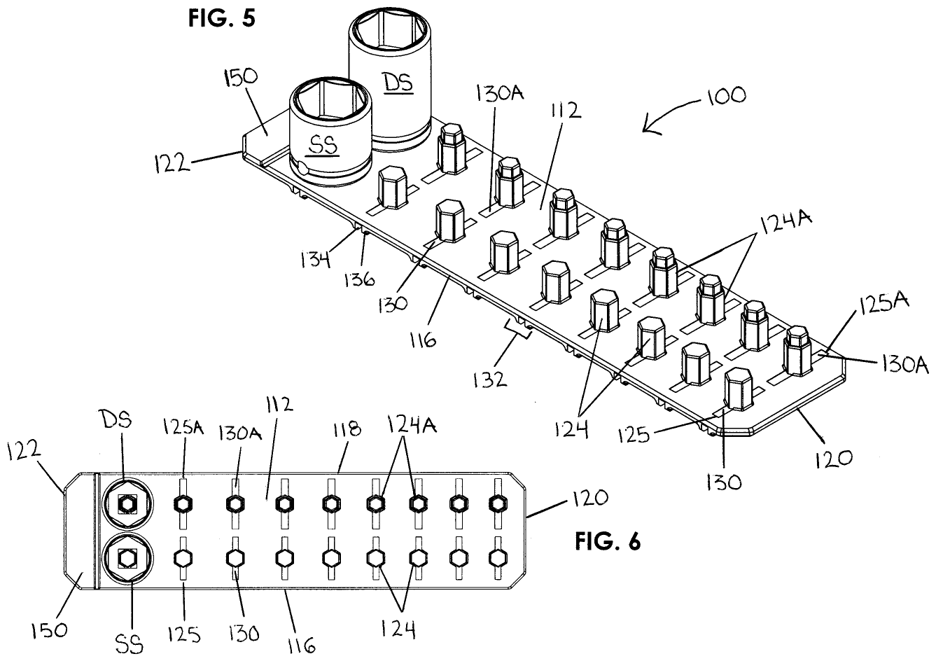

The socket holder is made of a flexible material such as thermoplastic rubber (TPR) or silicone and having a structure such that the socket holder may flex for attachment of the socket holder to almost any shape article. The socket holder includes magnets which will hold the socket to the top of the socket holder and which magnets also allow the bottom of the socket holder to magnetically adhere to different shaped ferrous objects, e.g. an automobile wheel well, the underside of an automobile hood, a work area or any other article. The socket holder may be made of different sizes for holding different size sockets, e.g. a ¼ inch socket or a ⅜ inch socket. FIGS. 1-4 show a first embodiment of the socket holder for holding twelve different sockets in one column, and FIGS. 5-8 show a second embodiment of the socket holder holding two different types of sockets in two columns. The invention will be described in further detail below.

Referring to FIGS. 1-4, there is shown a socket holder 10 having a top wall 12, bottom wall 14, first side wall 16, second side wall 18, first end wall 20 and second end wall 22. The top wall 12 includes a plurality of posts 24 for receiving a socket S. In a preferred embodiment, there are twelve posts, although the number of posts may vary without departing from the scope of the invention. Preferably, the posts 24 are of a diameter less than the underside of the socket and are not intended to frictionally mate with the underside of the socket but function as a guide or visual aid for receiving the socket. Posts 24 are shown in an X shape but may be of various shapes, including polygonal, round, S or the like. The posts 24 are preferably solid in structure. In the embodiment shown in FIG. 1, the posts are of a diameter adjusted for the size of the socket, e.g. a ¼ inch socket or a ⅜ inch socket. The posts height may also be adjusted for a shallow socket or a deep socket as seen, for example, in FIG. 5. Adjacent and under the posts 24 are openings 25 in the top wall 12/bottom wall 14. The openings 25 are to expose a magnet 30 in the top wall to hold the socket to the socket holder. The magnet 30 is preferably flush with the surface of top wall 12. The magnet 30 is preferably rectangular in shape and a neodymium magnet. The strength of the magnet may vary depending primarily on the size of the socket, and to a lesser degree on the needs of attaching the socket holder to a ferrous surface. The magnet strength can be adjusted to the needs of the user but must be sufficiently strong to keep the sockets in place and attach to a ferrous surface.

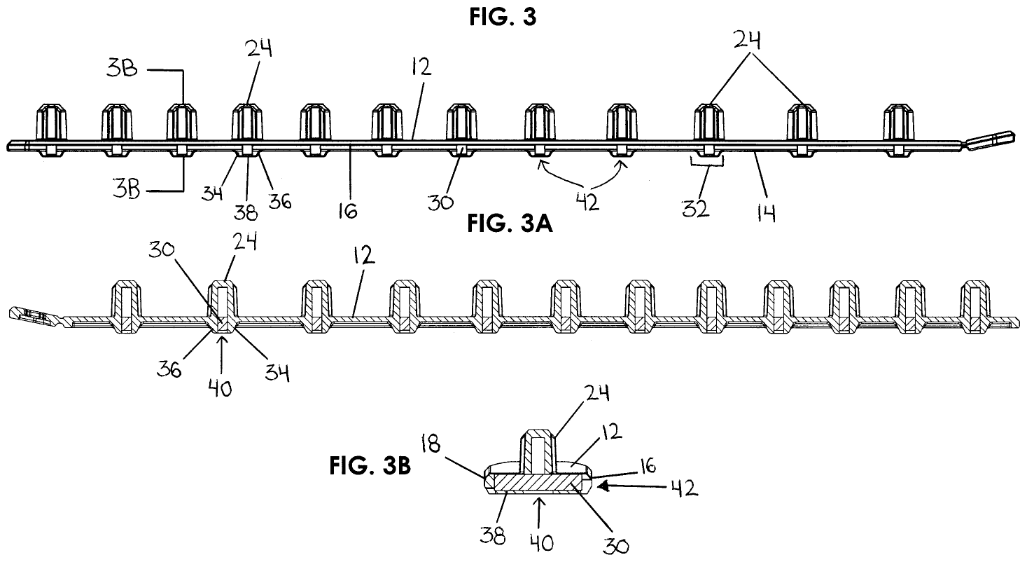

Referring to FIGS. 3, 3A, 3B and 4, there are retaining members 32 extending downwardly from bottom wall 14 and having legs 34, 36 and a base 38. There is an opening 40 in base 38 for exposing magnet 30. Retaining member 32 is adapted to receive and hold magnet 30 by friction fit.

Referring to FIGS. 3 and 3A, side wall 16 includes an opening 42 in conjunction with the open area of retaining member 32 for receiving magnet 30 which is held in retaining member 32 by friction fit. Second side wall 18 does not include an opening as in the first side wall and may be closed or include a small opening less than the size of the magnet 30 for retaining magnet 30 in retaining member 32.

Referring to FIG. 4, bottom wall 14 includes ribs 46, 48, preferably having a height the same as side walls 16 and 18. Ribs 46, 48 provide structural support to the socket holder 10 while at the same time providing flexibility to socket holder 10. This structure and the use of the TPR or silicone provides for the flexibility of the socket holder.

The end wall 22 includes an aperture 50 for hanging the socket holder. There is a crease 52 allowing for end wall 56 to mold to have an upward shape for hanging the socket holder.

The strip 12 is preferably molded by injection molding, preferably using TPR or silicone, although similar materials may be used. The magnets 30 are inserted in openings 42. The same mold used to make the flexible strip 12 may also be used to make a non-flexible magnetic socket holder by using a non-flexible material such as ABS (acrylonitrile butadiene styrene). Presently preferred dimensions of the strip for a ¼ inch socket holder are 8 to 10 inches in length; 0.8 to 1 inch in width; 0.48 to 0.52 inches in height; opening 25 is 0.6 to 0.9 inches in length and 0.10 to 0.13 inches in width; opening 42 is 0.11 to 0.13 inches in height and width; posts 24 are 0.24 inches in width and 0.30 in height. Presently preferred dimensions of the strip for a ⅜ inch socket holder are 12 to 14 inches in length; 0.9 to 1.2 inches in width; 0.55 to 0.60 inches in height; opening 25 is 0.6 to 0.9 inches in length and 0.10 to 0.13 inches in width; opening 42 is 0.11 to 0.13 inches in height and width; posts 24 are 0.37 inches in width and 0.30 in height.

Referring to FIGS. 5-8, there is shown a second embodiment of the socket holder having two columns of posts for receiving different size sockets such as a shallow socket SS and a deep socket DS as shown, for example, in FIGS. 5 and 6. In this embodiment, one set of posts are 0.43 inches in height and 0.37 inches in width and the second set of posts are 0.58 inches in height and 0.25 inches in width for holding a shallow socket and deep socket, respectively. The structure of this embodiment is substantially similar to the embodiment in FIGS. 1-4 and is described below.

Referring to FIGS. 5-8, there is shown a socket holder 100 having a top wall 112, bottom wall 114, first side wall 116, second side wall 118, first end wall 120 and second end wall 122. The top wall 112 includes a plurality of posts 124 for receiving a first size socket, a shallow socket, and a plurality of posts 124A for receiving a second size socket, a deep socket. Preferably, the posts 124 and 124A are of a diameter less than the underside of the sockets and are not intended to frictionally mate with the underside of the sockets but function as a guide or visual aid for receiving the sockets. Posts 124, 124A may be of various shapes, including polygonal, X, round, S or the like. In the embodiment shown in FIG. 5, there are two columns of nine posts 124, 124A and the posts are of a diameter adjusted for the size of the socket. Adjacent the posts 124, 124A are openings 125, 125A in the top wall 112/bottom wall 114. The openings are to expose magnets 130, 130A in the top wall to hold the sockets to the socket holder. The magnets 130, 130A are preferably rectangular in shape and a neodymium magnet.

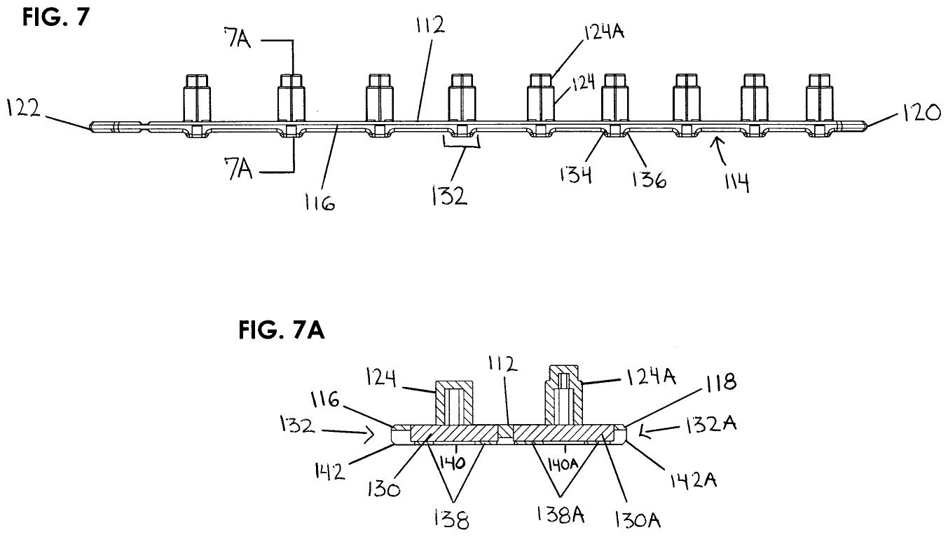

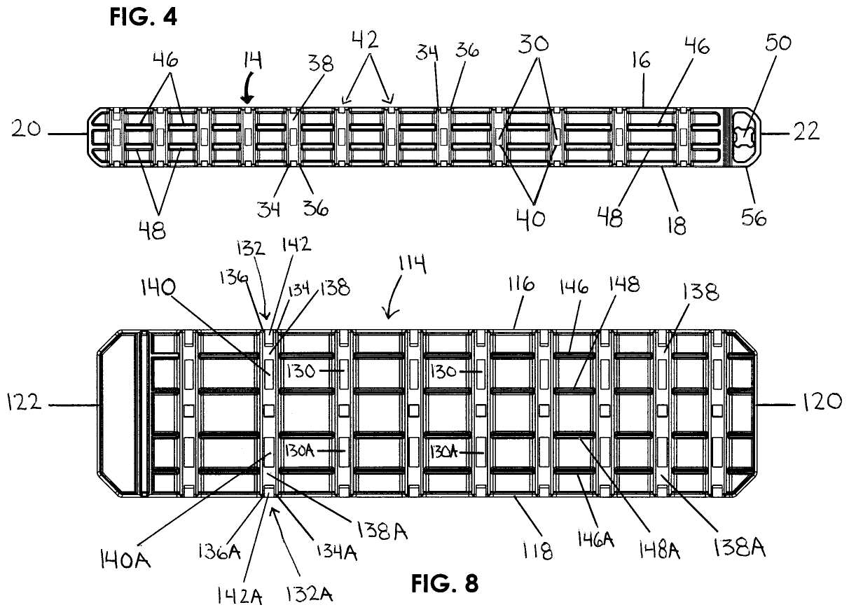

Referring to FIGS. 7, 7A and 8, there are retaining members 132, 132A extending downwardly from bottom wall 114 and having legs 134, 136, 134A, 136A and a base 138, 138A. There is an opening 140, 140A in base 138, 138A for exposing magnets 130, 130A. Retaining members 132, 132A are adapted to receive and hold magnets 130, 130A by friction fit.

Referring to FIGS. 7, 7A and 8, side walls 116, 118 include openings 142, 142A in conjunction with the open area of retaining member 132, 132A for receiving magnets 130, 130A which are held in retaining members 132, 132A by friction fit. The openings 142, 142A in the first and second side walls are closed in the interior thereof for retaining magnets 130, 130A in retaining members 132, 132A.

Referring to FIG. 8, bottom wall 114 includes ribs 146, 148, 146A, 148A preferably having a height the same as side walls 116 and 118 and providing structural support to the socket holder 100 while at the same time also allowing flexibility to socket holder 100.

End wall 122 may have space 150 for a brand name or logo. Like socket holder 10, socket holder 100 may be made by injection molding using TPR or silicone.

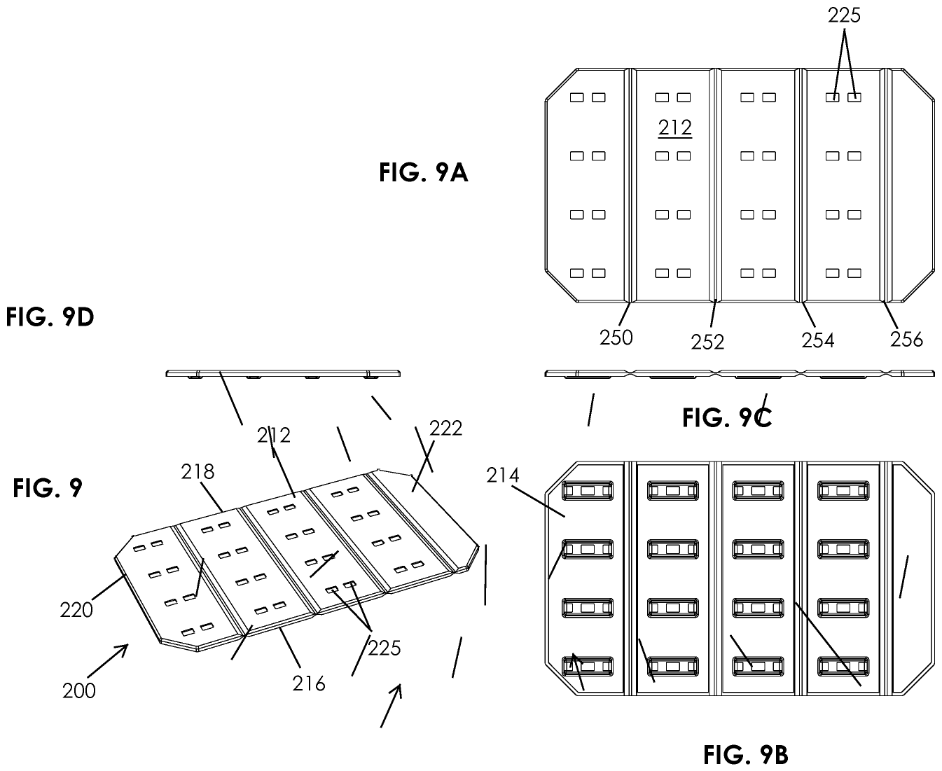

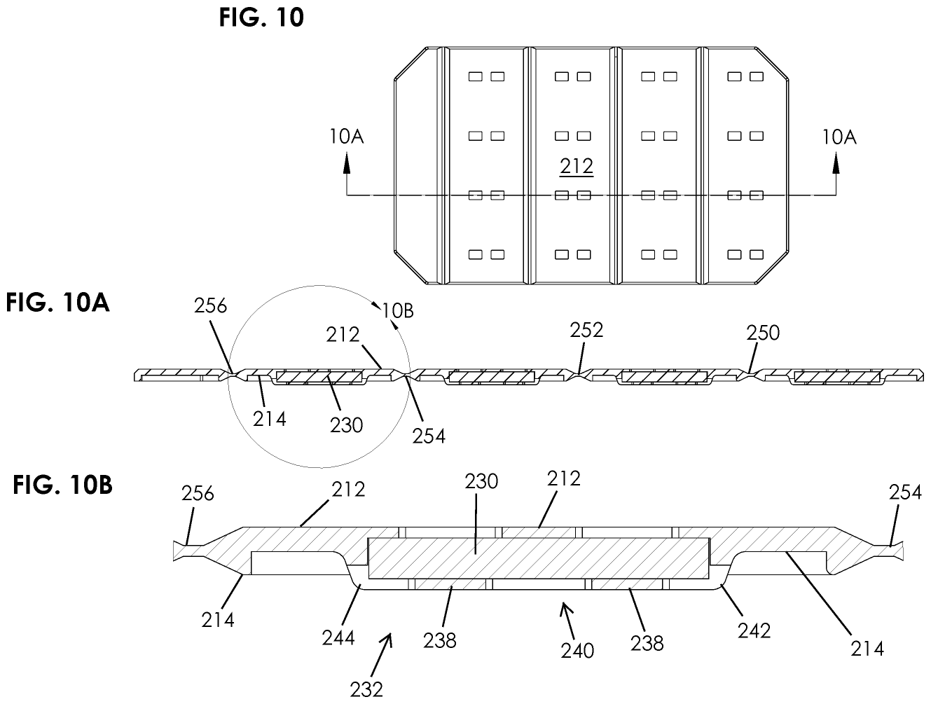

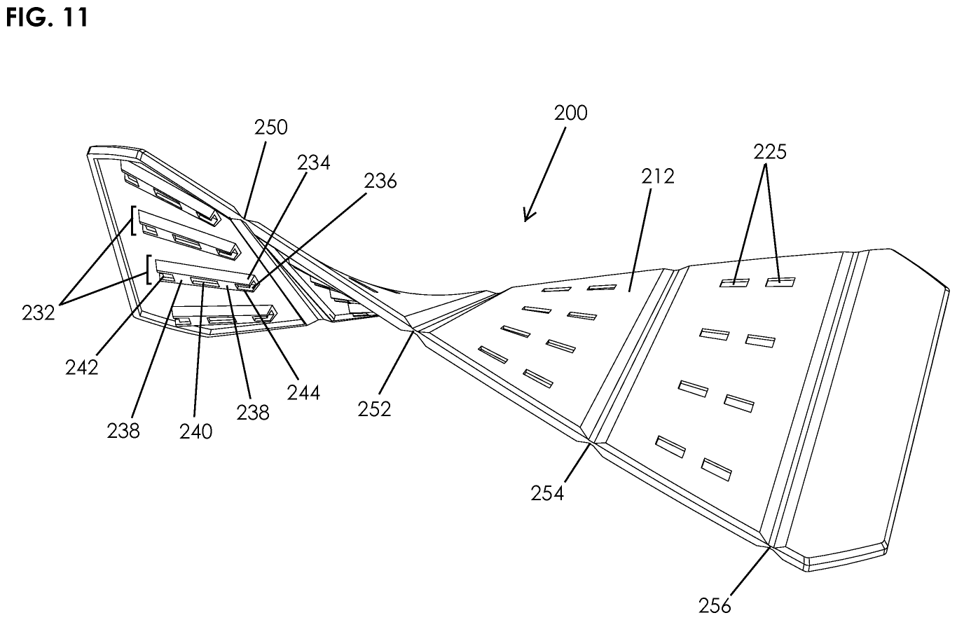

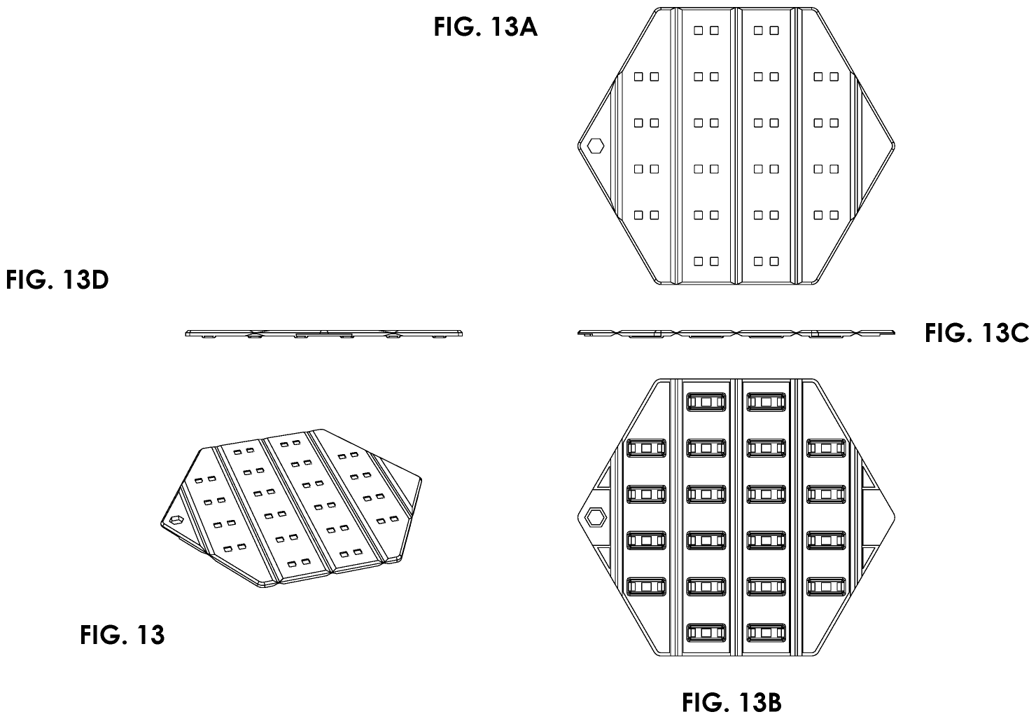

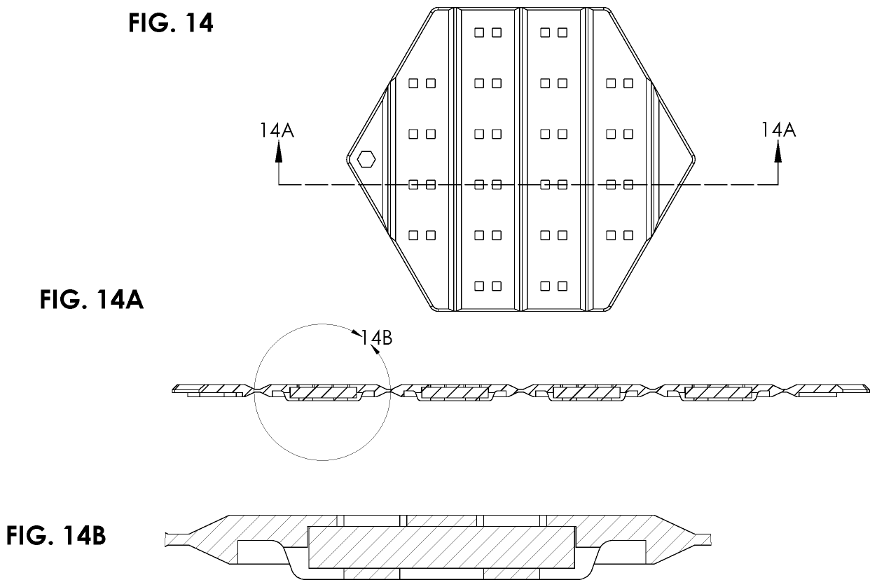

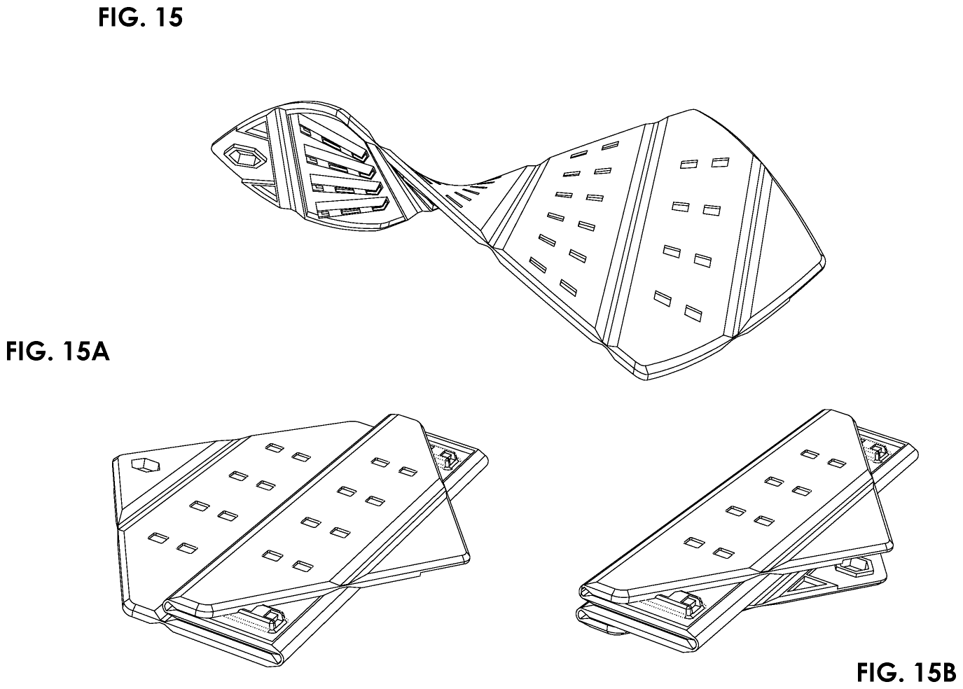

FIGS. 9-15 disclose the flexible magnetic mat invention useful in holding tools, including keeping the tools organized. FIGS. 9-12 show a rectangular embodiment of the mat and FIGS. 13-15 show a hexagonal embodiment of the mat.

Referring to FIGS. 9-13, there is shown a flexible magnetic mat 200 having a top wall 212, bottom wall 214, first side wall 216, second side wall 218, first end wall 220 and second end wall 222. The top wall 212 includes a plurality of openings 225 in the top wall 212/bottom wall 214. The openings 225 are to expose a magnet 330 in the top wall to hold the tools. The magnet 330 is preferably flush with the surface of top wall 212. The magnet 330 is preferably rectangular in shape and a neodymium magnet. The strength of the magnet may vary depending primarily on the size of the mat and the type of tools to be held, and to a lesser degree on the needs of attaching the mat to a ferrous surface. The magnet strength can be adjusted to the needs of the user but must be sufficiently strong to keep the tools in place and attach to a ferrous surface.

Referring to FIGS. 9C, 10A, 10B and 11, there are retaining members 232 extending downwardly from bottom wall 214 and having legs 234, 236 and a base 238. There is an opening 240 in base 238 for exposing magnet 230. Retaining member 232 includes open ends 242, 244 for receiving magnet 230. After the mat is molded, the magnets 230 are inserted into retaining members 232 through one of ends 242 and 244. Retaining member 232 is adapted to receive and hold magnet 230 by friction fit.

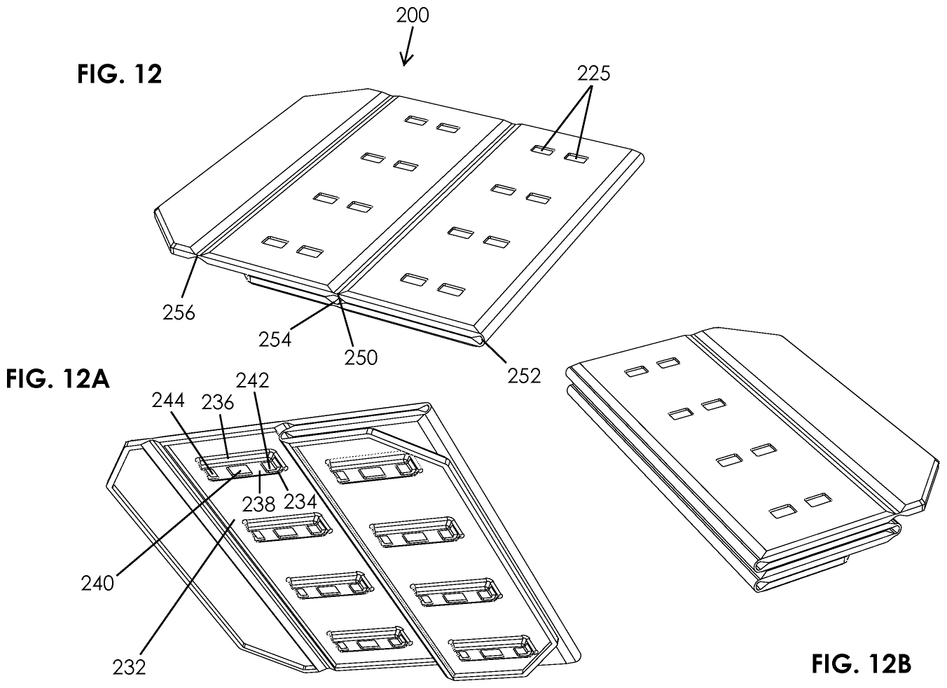

The mat 200 includes creases 250, 252, 254 and 256 having a reduced thickness to allow for the folding of mat 200 as shown in FIGS. 12, 12A and 12B.

The mat 200 is preferably molded by injection molding, preferably using TPR or silicone, although similar materials may be used. The magnets 230 are inserted in openings 242 or 242 of retaining members 232. The same mold used to make the flexible mat 200 may also be used to make a non-flexible magnetic mat by using a non-flexible material such as ABS (acrylonitrile butadiene styrene). Presently preferred dimensions of the mat are 8.75 in. length×5.5 in. width×0.19 in. thick.

Referring to FIGS. 13-15, there is shown a second embodiment of the mat having a hexagonal shape. This embodiment is substantially the same as FIGS. 9-12, except for the shape.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. For example, while the preferred embodiments are to have the magnet exposed at least in part in the top wall and the base of the retaining member, the magnet may be covered by a layer of material. Such modifications being within the ability of one skilled in the art form a part of the present invention and are embraced by the appended claims.

It is claimed:

1. A flexible magnetic mat comprising
a flexible mat having a top wall, a bottom wall, a first side wall and a second side wall,
the top wall having a plurality of openings each adapted to expose a magnet,
the bottom wall having a retaining member extending downwardly from the bottom wall under each opening and adapted to receive a magnet,
the retaining member having at least one opening adapted to receive a magnet and retain the magnet by friction fit,
a magnet is inserted in each of the retaining members through the at least one opening in the retaining member, and
wherein the top wall of the flexible mat is adapted to magnetically hold tools and the bottom wall of the flexible mat is adapted to magnetically attach to different shaped metal surfaces.

2. The flexible magnetic mat of claim 1 wherein the magnet is rectangular in shape.

3. The flexible magnetic mat of claim 1 wherein the shape of the mat is polygonal in shape.

4. The flexible magnetic mat of claim 1 wherein the retaining member comprises a first leg extending downwardly from the bottom wall, a second leg extending downwardly from the bottom wall and at least one base member joining said first leg and said second leg.
